(19) United States
(12) Patent Application Publication
(10) Pub. No.: US 2018/0136833 A1
(43) Pub. Date: May 17, 2018

(54) DETECTION OF CLEANING GESTURES

(71) Applicant: Rauland-Borg Corporation, Mount Prospect, IL (US)

(72) Inventors: Michael C. Perkins, Havana, IL (US); Brian W. Kidder, Libertyville, IL (US)

(21) Appl. No.: 15/353,285

(22) Filed: Nov. 16, 2016

(51) Int. Cl. G06F 3/0488; G06F 3/0482; G06F 3/0484; G06F 3/16

(52) U.S. Cl. CPC G06F 3/04883; G06F 3/167; G06F 3/04845; G06F 3/0482

(57) ABSTRACT

Embodiments of the disclosure provide an electronic device with a cleaning gestures feature. The electronic device includes a touchscreen configured to display information and receive touch inputs, a non-transitory computer-readable medium having processor-executable instructions stored thereon, and a processor configured to execute the processor-executable instructions to: (a) detect a cleaning gesture received at the touchscreen, the cleaning gesture comprising one or more touch inputs on the touchscreen; (b) in response to receiving the cleaning gesture, enter a cleaning mode, the cleaning mode comprising disabling one or more functions and/or gestures of the touchscreen; and (c) conditionally terminate the cleaning mode.

### BACKGROUND

Many computers and other electronic devices use displays that take advantage of touchscreens. These touchscreens often include a transparent or semitransparent overlay to a display of a display device. Most displays made in recent years are flat, but some are curved or can have other shapes. The touchscreen usually conforms closely to the shape of the display in all three directions, that is, width, length, and curvature (if the display is not entirely flat).

In most examples, touchscreens, such as capacitive or optical touchscreens, are a part of the corresponding display devices. Other examples of touchscreen devices, however, may also include configurations where the touch sensor is not contained within the display device but is rather an external sensor of a different type, such as an x-y infrared beam system or a surface-acoustic wave system.

Regardless of the type of touchscreen device, there is typically provided a display device which has a surface providing the display and on which a user may provide input through a touch action or an action resembling touching. Actions resembling touch may include sensing a finger, stylus, or an input device that comes close to a touchscreen without touching the screen.

### SUMMARY

In an exemplary embodiment, an electronic device with a cleaning gestures feature is provided. The electronic device includes a touchscreen configured to display information and receive touch inputs, a non-transitory computer-readable medium having processor-executable instructions stored thereon, and a processor configured to execute the processor-executable instructions to: (a) detect a cleaning gesture received at the touchscreen, the cleaning gesture comprising one or more touch inputs on the touchscreen; (b) in response to receiving the cleaning gesture, enter a cleaning mode, the cleaning mode comprising disabling one or more functions and/or gestures of the touchscreen; and (c) conditionally terminate the cleaning mode.

In an exemplary embodiment, a method for processing a cleaning gesture is provided. The method is performed by an electronic device with a touchscreen. The method includes detecting a cleaning gesture received at the touchscreen, the cleaning gesture comprising one or more touch inputs on the touchscreen. In response to receiving the cleaning gesture, the method further includes entering a cleaning mode, the cleaning mode involving disabling one or more functions and/or gestures of the touchscreen. The method further includes conditionally terminating the cleaning mode.

In an exemplary embodiment, a non-transitory computer readable medium containing program instructions for causing an electronic device with a touchscreen to perform a method for processing a cleaning gesture is provided. The non-transitory computer readable medium causes the electronic device to perform the method including: (a) detecting a cleaning gesture received at the touchscreen, the cleaning gesture comprising one or more touch inputs on the touchscreen; (b) in response to receiving the cleaning gesture, entering a cleaning mode, the cleaning mode comprising disabling one or more functions and/or gestures of the touchscreen; and (c) conditionally terminating the cleaning mode.

### BRIEF DESCRIPTION OF THE SEVERAL VIEWS OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is an example environment showing an exemplary touchscreen and an exemplary cleaning gesture according to an exemplary embodiment of the disclosure;

FIG. 2 illustrates components of an exemplary electronic device according to an exemplary embodiment of the disclosure;

FIG. 3 illustrates an exemplary procedure for detecting and processing a cleaning gesture according to exemplary embodiments of the disclosure;

FIG. 4 illustrates another exemplary procedure for detecting and processing a cleaning gesture according to an exemplary implementation of the disclosure; and

FIG. 5 illustrates yet another exemplary procedure for detecting and processing a cleaning gesture according to exemplary embodiments of the disclosure.

### DETAILED DESCRIPTION

Display surfaces are prone to getting contaminated with a variety of sources, and for touchscreens in particular, due to interaction with a user's digits, fingerprints are a major source of contamination. Other potential contaminants include food, spittle, dust, droplets from coughs and sneezes, etc. Thus, for contents of a touchscreen display to remain visible, a surface of the touchscreen display surface may need to be cleaned on a periodic basis. In some instances, if the touchscreen is on a device in a hospital or cleanroom setting, regular cleaning may be required to maintain cleanliness standards.

Cleaning a touchscreen display is usually accomplished manually, either on an as-needed basis or on a scheduled basis. But by their very nature, touchscreens are sensitive to touch, and therefore commonly react to the process of being cleaned (since the cleaning procedure involves touching the touchscreen display, unintended touch inputs may be received through the touchscreen display during cleaning).

One solution may be to shut down a touchscreen display device when it becomes necessary to clean the touchscreen. However, shutting down the device is often undesirable because of loss of usage while the device is shut down. In some cases, shutting the device down may not be an option at all when continuous operation is needed from the device (such as with respect to moving vehicles or manufacturing equipment), and thus cleaning the touchscreen display device down for cleaning may not be an option. Additionally, the process of rebooting the device after a cleaning procedure adds to the undesirable downtime of the device (especially with respect to devices, such as certain machinery, motor vehicles, manufacturing equipment, etc., which may take a significant amount of time to restart).

In certain instances, the touchscreen display device cannot be shut down by a user or a person performing the cleaning procedure because the controls that shut the device down are located remotely (e.g., not on the device itself), or the user or person performing the cleaning procedure may not be authorized to shut down the device. This may be the case, for example, in certain touchscreen display devices used in nurse-call systems, fire alarm systems, building environmental control systems, etc. In these cases, although the device could be shut down for cleaning, doing so may be impractical and dangerous from the perspective of losing functionality of an important safety system.

Embodiments of the disclosure provide a method for disabling a touchscreen of a touchscreen display device based on detection of cleaning gestures without requiring the touchscreen display device to be shut down. It will be appreciated that “cleaning gestures” refers to touch input on a touchscreen utilized for temporarily disabling input via the touchscreen. In an exemplary embodiment, in response to detecting a cleaning gesture, the device being cleaned is placed into a mode that, for a time, the device will not respond to further input through its touchscreen so that the touchscreen display surface can be cleaned while avoiding unintentional processing of touch actions on the touchscreen display surface during cleaning.

In general, various gestures have been used with respect to touchscreen display devices as a way of differentiating between user commands performed on user interfaces of the touchscreen display devices. These gestures include, for example, swipe, tap, double-tap, rotate, pinch, spread, tap, hold, slide, drag, flick, and other gestures. Thus, for an exemplary computing device having a touchscreen, the computing device may be configured to respond in different ways corresponding to different gestures being detected on the touchscreen of the computing device.

In addition, some of these gestures may be context-sensitive such that the effect of their usage depends upon the state of the computing device at the time of the gesture. For example, a pinching gesture when performed on a screen displaying a static image may cause the computing device to perform a zoom-out operation with respect to the static image, while performing the same pinching gesture on a screen displaying a desktop of an operating system may have no effect.

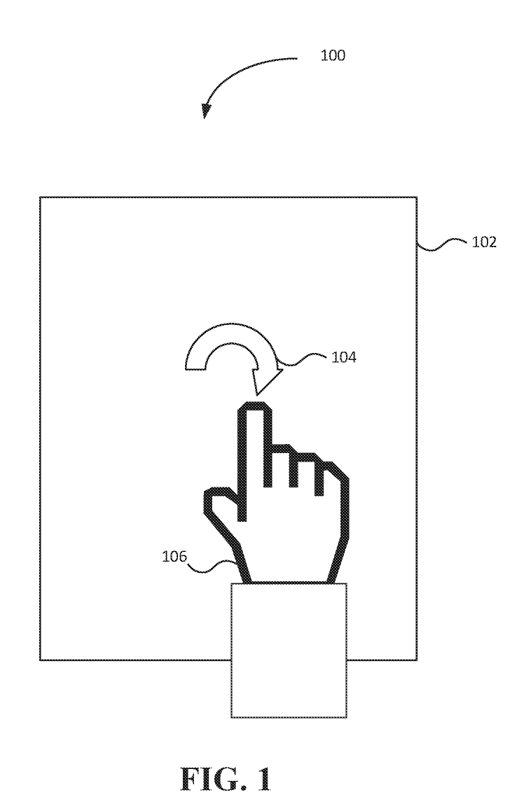

FIG. 1 is an example environment 100 showing a touchscreen surface 102 and a cleaning gesture 104 according to an embodiment of the disclosure. In some exemplary embodiments, the cleaning gesture 104 in FIG. 1 may be a gesture selected from the previous examples of gestures mentioned above. In one example, the cleaning gesture 104 may be a curved drag gesture as depicted in FIG. 1 corresponding to dragging an input object 106 such as a fingerprint or other object (e.g., a stylus or palm or cleaning rag) along a portion of a circular or elliptical or otherwise curved path. In another example, the cleaning gesture 104 may be a curved drag gesture corresponding to a complete revolution on a substantially circular or a substantially elliptical or an otherwise rounded path (e.g., dragging the input object 106 in the shape of an “O”).

In another exemplary embodiment, the cleaning gesture may be a zig-zag drag motion (e.g., dragging the input object 106 in the shape of a “Z”).

In other exemplary embodiments, the cleaning gesture may be comprised of a series of gestures, such as multiple curved drag gestures (e.g., multiple continuous offset circles corresponding to a circular swooping motion) or multiple repeated swipe gestures (e.g., multiple substantially parallel swipe motions in a particular gesture).

In other exemplary embodiments, the cleaning gesture may utilize multi-touch functionality of the touchscreen 102, such as detecting multiple points of contact in combination with a curved drag gesture.

It will be appreciated that the foregoing examples of gestures that may constitute a “cleaning gesture” are merely exemplary, and that other gestures or combinations of gestures may be utilized in accordance with other exemplary embodiments.

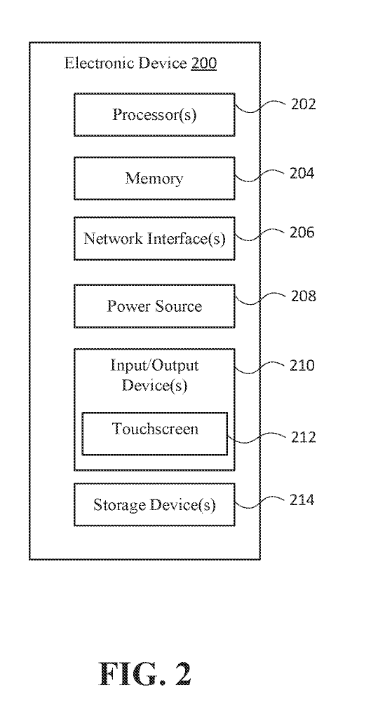

FIG. 2 illustrates a block diagram of exemplary hardware components for an electronic device 200 that may have a touchscreen similar to touchscreen 102 of FIG. 1, according to an exemplary embodiment of the disclosure. The electronic device 200 may include one or more processors 202, memory 204, network interfaces 206, power source 208, input/output (I/O) devices 210 including touchscreen 212, and storage devices 214. Although not explicitly shown in FIG. 0, each component provided is interconnected physically, communicatively, and/or operatively for inter-component communications in order to realize functionality ascribed to the electronic device 200. To simplify the discussion, the singular form will be used for all components identified in FIG. 0 when appropriate, but the use of the singular does not limit the discussion to only one of each component. For example, multiple processors may implement functionality attributed to processor 202.

Processor 202 is configured to implement functions and/or process instructions for execution within electronic device 200. For example, processor 202 executes instructions stored in memory 204 or instructions stored on a storage device 214. In certain embodiments, instructions stored on storage device 214 are transferred to memory 204 for execution at processor 202. Memory 204, which may be a non-transitory, computer-readable storage medium, is configured to store information within electronic device 200 during operation. In some embodiments, memory 204 includes a temporary memory that does not retain information stored when the electronic device 200 is turned off. Examples of such temporary memory include volatile memories such as random access memories (RAM), dynamic random access memories (DRAM), and static random access memories (SRAM). Memory 204 also maintains program instructions for execution by the processor 202 and serves as a conduit for other storage devices (internal or external) coupled to electronic device 200 to gain access to processor 202.

Storage device 214 includes one or more non-transitory computer-readable storage media. Storage device 214 is provided to store larger amounts of information than memory 204, and in some instances, configured for long-term storage of information. In some embodiments, the storage device 214 includes non-volatile storage elements. Non-limiting examples of non-volatile storage elements include floppy discs, flash memories, magnetic hard discs, optical discs, solid state drives, or forms of electrically programmable memories (EPROM) or electrically erasable and programmable (EEPROM) memories.

Network interfaces 206 are used to communicate with external devices and/or servers. The electronic device 200 may comprise multiple network interfaces 206 to facilitate communication via multiple types of networks. Network interfaces 206 may comprise network interface cards, such as Ethernet cards, optical transceivers, radio frequency transceivers, or any other type of device that can send and receive information. Non-limiting examples of network interfaces 206 include radios compatible with several Wi-Fi standards, 3G, 4G, Long-Term Evolution (LTE), Bluetooth®, etc.

Power source 208 provides power to electronic device 200. For example, electronic device 200 may be battery powered through rechargeable or non-rechargeable batteries utilizing nickel-cadmium or other suitable material. Power source 208 may include a regulator for regulating power from the power grid in the case of a device plugged into a wall outlet, and in some devices, power source 208 may utilize energy scavenging of ubiquitous radio frequency (RF) signals to provide power to electronic device 200.

Electronic device 200 may also be equipped with one or more I/O devices 210. I/O devices 210 are configured to: (a) receive inputs from a user or the environment; and/or (b) provide outputs to the user using tactile, audio, and/or video information. Examples of I/O devices 210 include output oriented devices such as a display screen (cathode ray tube (CRT) display, liquid crystal display (LCD) display, LCD/light emitting diode (LED) display, organic LED display, etc.), a sound card, a video graphics adapter card, speakers, magnetics, or any other type of device that may generate an output intelligible to a user. Examples of I/O devices 210 further include input oriented devices such as presence-sensitive screen or a touch-sensitive screen, a mouse, a keyboard, a video camera, microphone, a voice responsive system, or any other type of input device. Touchscreen 212 is identified in electronic device 200 as part of I/O devices 210.

The hardware components described thus far for electronic device 200 are functionally and communicatively coupled to achieve certain behaviors. In some embodiments, these behaviors are controlled by software running on an operating system of electronic device 200.

It will be appreciated that the electronic device 200 is merely exemplary, and that embodiments of the present disclosure are usable with respect to various other types of touchscreen-related electronic devices and computing devices having different components and configurations.

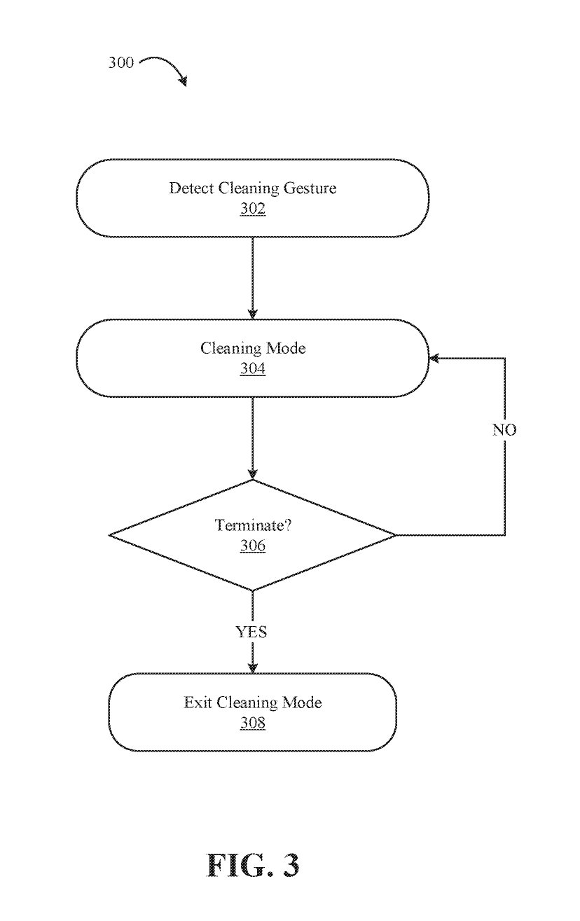

FIG. 3 illustrates a procedure 300 for detecting and processing a cleaning gesture according to exemplary embodiments of the disclosure. At stage 302, an electronic device 200 detects a cleaning gesture using touchscreen 212. As discussed above with respect to FIG. 1, examples of a cleaning gesture include a curved drag gesture, multiple continuous curved drag gestures, a zig-zag gesture, multiple parallel or repeated swipes in a particular direction, etc.

In response to the electronic device 200 detecting the cleaning gesture, the electronic device 200 enters a cleaning mode at stage 304. In the cleaning mode, one or more of the touchscreen functions and/or gestures is disabled. Disabled functions and/or gestures when performed on touchscreen 212 do not cause the electronic device 200 to respond to the functions and/or gestures.

In an exemplary embodiment, only one gesture is allowed or enabled in the cleaning mode, for example, a “done-cleaning” gesture when performed on touchscreen 212 in cleaning mode may enable all functions and/or gestures on touchscreen 212 (discussed in further detail below). In other exemplary embodiments, more than one gesture may be enabled in the cleaning mode for specified functionality. In still other exemplary embodiments, the touch sensor of the touchscreen 212 may be completely disabled for a set period of time (e.g., for a predetermined duration for the cleaning mode).

The initiation of the cleaning mode via the cleaning gesture may cause the electronic device 200 to indicate on the touchscreen 212 that the touchscreen 212 is in cleaning mode. This may be accomplished by use of color, icons, still images or pictures, video images, combinations of words, or a combination of these that in some way represents that one or more gestures have been disabled. In some embodiments, after entering the cleaning mode, the touchscreen 212 displays a countdown timer showing when the touchscreen 212 will return to normal operation (that is, enable the disabled functions and/or gestures). In some embodiments, after entering the cleaning mode, the electronic device 200 plays sounds, including tones and voice messages, that indicate the cleaning mode is in effect.

Stage 306 corresponds to the electronic device determining whether or not the cleaning mode should be terminated.

As mentioned above, in an exemplary embodiment, after entering the cleaning mode, the electronic device 200 may only respond to a pre-defined end-of-cleaning or a “done-cleaning gesture” to determine that the cleaning mode should be terminated. If such a done-cleaning gesture is detected during the cleaning mode, the cleaning mode is terminated at stage 308.

The done-cleaning gesture is chosen as a suitable gesture not likely to occur during a cleaning operation. In some embodiments, since cleaning a touchscreen involves physically rubbing or scrubbing the surface of the touchscreen, “still” gestures, such as, pressing an icon and holding or pressing and holding two icons apart from one another, are preferred done-cleaning gestures. In other embodiments, a two finger press-and-hold anywhere on the touchscreen 212 may serve as a done-cleaning gesture.

In some embodiments, a done-cleaning gesture may include touching in succession the same area on touchscreen 212. For example, after the electronic device 200 enters the cleaning mode, a user may tap the same place on the touchscreen 212 three or more times in rapid succession to terminate cleaning mode.

In some embodiments, after entering the cleaning mode, the electronic device 200 displays on touchscreen 212 an image of a pattern that, if traced with some degree of accuracy, will terminate the cleaning mode and return the touchscreen operation to normal mode.

In some embodiments, after entering the cleaning mode, the electronic device 200 displays on touchscreen 212 a target or an icon that, if held for a given amount of time, will terminate the cleaning mode and return the operation of touchscreen 212 to normal mode. In some aspects, this may or may not include a confirm function whereby a user would be instructed to press an icon or otherwise indicate that the cleaning mode should be terminated.

In another exemplary embodiment, determining whether or not the cleaning mode should be terminated at stage 306 may include determining whether a timer has expired and/or determining whether there is a renewal of the cleaning mode. In some embodiments, the cleaning mode expires after a countdown timer displayed on touchscreen 212 reaches zero. If the cleaning mode is not renewed, then at stage 308 the cleaning mode is terminated, but if the cleaning mode is renewed, then the electronic device 200 stays in cleaning mode by returning to stage 304.

In some embodiments, at stage 306, if cleaning the touchscreen 212 is taking longer than a fixed cleaning mode timer, and a user wishes to prevent the cleaning mode from terminating, the electronic device may display an image on touchscreen 212 that, if traced with some degree of accuracy, will renew the cleaning mode and keep the electronic device in the cleaning mode for another period of time. In some embodiments, in the cleaning mode before a time expires, the electronic device 200 may display on the touchscreen 212 a target or an icon that, if held for a given amount of time, will terminate the cleaning mode at stage 308 and return the operation of touchscreen 212 to normal mode. In some aspects, a confirm function or prompt is provided to the user whereby the user would be instructed to press an icon or somehow otherwise indicate that cleaning mode should be terminated. In some embodiments, when the cleaning mode is renewed, the electronic device 200 may play a sound, including tones and voice messages, to indicate the renewal of cleaning mode. Cleaning mode may be renewed multiple times.

Thus, in some exemplary embodiments, the cleaning mode is terminated when there is no renewal of the cleaning mode at stage 306 after the expiration of a cleaning mode timer. In other words, the electronic device 200 may return to normal operation of touchscreen 212 after a fixed time following the initiation of the cleaning mode if no input is received that renews the cleaning mode. The fixed time following the initiation of the cleaning mode may be programmable to be, for example, between 10 seconds and 30 seconds. If the cleaning mode is renewed one or more times, the electronic device 200 may return to normal operation of the touchscreen 212 after a fixed time following the last renewal of the cleaning mode. The fixed time following the renewal of the cleaning mode may be different from the fixed time following the initiation of the cleaning mode (e.g., a shorter timer may be provided with respect to renewals of the cleaning mode than for a timer used with respect to initiation of the cleaning mode).

The electronic device 200 may further determine to terminate the cleaning mode at stage 306 after sensing a time interval of no activity on the touchscreen 212. This time interval may be less than the fixed time following initiation of the cleaning mode.

The electronic device 200 may further terminate cleaning mode after sensing an end-of-cleaning or a done-cleaning gesture when in cleaning mode, as discussed above.

Additionally, sounds, including tones and voice messages, may be played by the electronic device 200 to indicate that cleaning mode has been terminated at stage 308. In some instances, after the electronic device 200 terminates the cleaning mode, the electronic device 200 provides a graphical indication on touchscreen 212 that the cleaning mode is terminated. This graphical indication may include use of color, icons, still images or pictures, video images, combinations of words, or a combination of these that in some way represents that one or more gestures have been re-enabled.

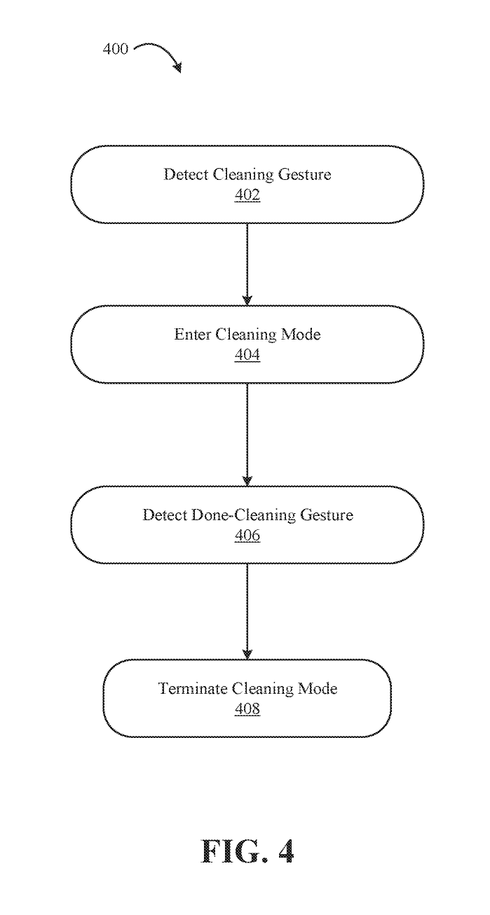

FIG. 4 illustrates a procedure 400 for detecting and processing a cleaning gesture according to an exemplary implementation of the disclosure. At stage 402, an electronic device 200 detects a cleaning gesture using touchscreen 212.

At stage 404, in response to the electronic device 200 detecting the cleaning gesture, the electronic device 200 enters a cleaning mode.

At stage 406, the electronic device 200 detects a done-cleaning gesture using touchscreen 212.

At stage 408, in response to the electronic device 200 detecting the done-cleaning gesture, the electronic device 200 terminates the cleaning mode. In the exemplary embodiment of FIG. 4, the electronic device 200 remains in cleaning mode until it receives a done-cleaning gesture.

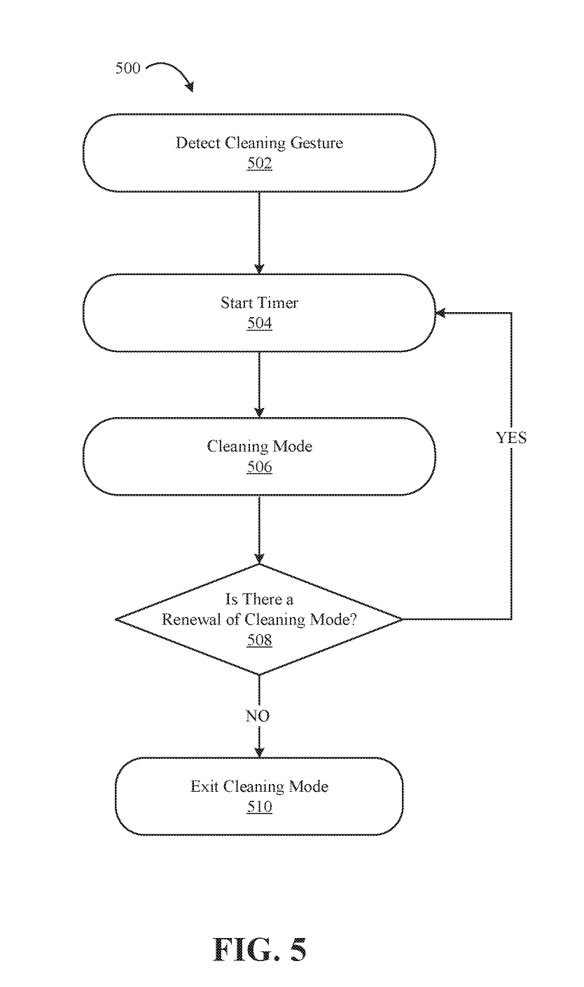

FIG. 5 illustrates another exemplary procedure 500 for detecting and processing a cleaning gesture according to an exemplary implementation of the disclosure. At stage 502, an electronic device 200 detects a cleaning gesture using touchscreen 212.

In response to the electronic device 200 detecting the cleaning gesture, a timer is set/started at stage 504 and cleaning mode is initiated at stage 506. Following the initiation of the cleaning mode, the timer may count up to a fixed time; or following the initiation of the cleaning mode, the timer may count down from a fixed time. The time remaining may be displayed on the touchscreen to show the user how much time is left for the cleaning mode.

At stage 508 (which may occur upon the expiration of the timer or, alternatively, at any time while the electronic device 200 is in the cleaning mode), the electronic device 200 determines whether there is a renewal of the cleaning mode. If there is a renewal of the cleaning mode, the electronic device 200 sets/adjusts a time of the timer at stage 504. The adjustment of the time may involve adding more time to a countdown timer. For example, if the timer corresponds to 5 seconds being left in cleaning mode, and a renewal of the cleaning mode was performed, then the timer may be adjusted to 25 seconds left in cleaning mode. The adjustment of the time may also involve extending a termination time for an up-counter timer. For example, if the timer corresponds to 25 seconds elapsed and the cleaning mode is set to terminate at 30 seconds elapsed, then performing a renewal of the cleaning mode may extend the termination time from 30 seconds to 45 seconds. At stage 508, if there is no renewal of the cleaning mode, once the timer expires for a countdown timer or reaches a termination time for an up-counter timer, then the cleaning mode is terminated at stage 510.

Additionally, the electronic device 200 may be further configured such that if a “done-cleaning gesture” (e.g., as discussed above with respect to FIG. 4) is received while the electronic device 200 is in the cleaning mode at stage 506, the electronic device 200 immediately exits the cleaning mode (stage 510) without waiting for the expiration of the timer.

Embodiments of the disclosure may be applied in a life safety or mission critical environments. For example, the embodiments may be utilized in a hospital or patient care facility. A typical hospital includes many care units, such as an Intensive Care Unit (ICU), a Cardiology Unit, an Emergency Care Unit, a General Surgery Unit, an Oncology Unit, a Pediatrics Unit, and a Pharmacy Unit, among others. Further, each of these units is associated with staff members and equipment to provide care for patients of the hospital. So hospitals are generally equipped with nurse call systems, which include various devices located throughout the hospital through which patients and/or nurses are able to communicate over a network (typically an internal hospital network) with one or more centralized nurse stations. The nurse call system helps in organizing hospital resources and facilitating communication in the hospital environment so as to enhance patient safety and improve staff efficiency.

The nurse call system may include, for example, patient TV systems, corridor lights, bedside stations, bath stations, emergency call stations, staff terminals, etc. One nurse call component may be a wall-mounted device with a touchscreen located close to a patient bed, which provides various functionality to the patient including, for example, two-way audio communication that allows for a call to be placed between a patient and staff members. A staff terminal with a touchscreen may also be present in a patient's room, allowing staff members to set alerts, initiate audio communication, and update patient status in a room. A nurse master console is another component with a touchscreen having similar functionality to the staff terminal which may be located at the nurse's station. Some of these nurse call devices have no power switch available to the patient or staff member. Additionally, the hospital environment requires minimum cleanliness standards, prompting frequent and regular cleaning and disinfecting of equipment and components in the nurse call system.

In an embodiment, a nurse call device or nurse call component with a touchscreen is used to signal a state of emergency. Because it is advantageous to keep the device on during cleaning (such that a user is able to quickly signal a state of an emergency, if needed), the device may enter cleaning mode after detecting a cleaning gesture. While cleaning, and before a fixed time following the entering of the cleaning mode, when an emergency occurs and the nurse call device is needed to be operational in a normal mode, then a done-cleaning gesture may be performed on the touchscreen. This done-cleaning gesture may include, for example, rapidly tapping a single point on the touchscreen to terminate the cleaning mode (which is a gesture that would is not likely to be a result of a cleaning action and would be an intuitive gesture for a patient or other user in need of help).

In addition to nurse call systems, embodiments of the disclosure may be utilized in other mission critical or life safety environments as well. For example, in an industrial context, it is advantageous to be able to clean industrial machinery (e.g., locomotives, printing presses, manufacturing equipment, etc.) with touchscreens that are used for control operations without turning off such machinery (or the touchscreen components of such machinery). Other examples include security system environments and various medical treatment devices (e.g., infusion pumps for intravenous (I-V) therapy).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electronic device with a cleaning gestures feature, the electronic device comprising:
a touchscreen, configured to display information and receive touch inputs;
a non-transitory computer-readable medium having processor-executable instructions stored thereon; and
a processor configured to execute the processor-executable instructions to:
detect a cleaning gesture received at the touchscreen, the cleaning gesture comprising one or more touch inputs on the touchscreen;
in response to receiving the cleaning gesture, enter a cleaning mode, the cleaning mode comprising disabling one or more functions and/or gestures of the touchscreen; and
conditionally terminate the cleaning mode.

2. The electronic device according to claim 1, wherein the cleaning gesture comprises one or more selected from the group consisting of: swipe, tap, double-tap, rotate, pinch, spread, tap, hold, slide, drag, flick, circle gesture, multiple continuous offset circles, a zig-zag motion, and parallel or repeated swipes in a particular direction.

3. The electronic device according to claim 1, wherein in the cleaning mode, a done-cleaning gesture is the only gesture enabled, the done-cleaning gesture comprising a gesture that causes the processor to terminate the cleaning mode.

4. The electronic device according to claim 1, wherein in the cleaning mode, the touchscreen displays information indicating that the electronic device is in the cleaning mode, the information comprising one or more of colors, icons, still images, pictures, video images, or combination of words.

5. The electronic device according to claim 1, wherein in the cleaning mode, the touchscreen displays an image, and wherein the image when traced with touch inputs will cause the processor to terminate the cleaning mode.

6. The electronic device according to claim 1, further comprising a speaker configured to play sounds indicating that the cleaning mode is in effect, the sounds including tones and voice messages.

7. The electronic device according to claim 1, wherein the processor is further configured to:
renew the cleaning mode, the renewing comprising delaying the conditionally terminating the cleaning mode.

8. The electronic device according to claim 7, wherein in the cleaning mode, the touchscreen displays an image, and wherein the image when traced with touch inputs will cause the processor to renew the cleaning mode.

9. The electronic device according to claim 1, wherein the processor terminates the cleaning mode after a fixed time following the entering of the cleaning mode.

10. The electronic device according to claim 1, wherein the processor terminates the cleaning mode after sensing a time interval of no activity on the touchscreen.

11. A method for processing a cleaning gesture, the method performed by an electronic device with a touchscreen, the method comprising:
detecting a cleaning gesture received at the touchscreen, the cleaning gesture comprising one or more touch inputs on the touchscreen;
in response to receiving the cleaning gesture, entering a cleaning mode, the cleaning mode comprising disabling one or more functions and/or gestures of the touchscreen; and
conditionally terminating the cleaning mode.

12. The method according to claim 11, wherein the cleaning gesture comprises one or more selected from the group consisting of: swipe, tap, double-tap, rotate, pinch, spread, tap, hold, slide, drag, flick, circle gesture, multiple continuous offset circles, a zig-zag motion, and parallel or repeated swipes in a particular direction.

13. The method according to claim 11, wherein in the cleaning mode, a done-cleaning gesture is the only gesture enabled, the done-cleaning gesture comprising a gesture that causes the processor to terminate the cleaning mode.

14. The method according to claim 11, wherein the conditionally terminating the cleaning mode comprises one or more selected from the group consisting of:
terminating the cleaning mode after a fixed time has elapsed following the entering of the cleaning mode;
terminating the cleaning mode after sensing a time interval of no activity on the touchscreen;
terminating the cleaning mode after an image displayed on the touchscreen is traced with touch inputs; and
terminating the clean mode after receiving a done-cleaning gesture on the touchscreen, the done cleaning gesture being the only gesture enabled in cleaning mode.

15. The method according to claim 11, further comprising:
renewing the cleaning mode, the renewing comprising delaying the conditionally terminating the cleaning mode.

16. A non-transitory computer readable medium containing program instructions for causing an electronic device with a touchscreen to perform a method for processing a cleaning gesture, the method comprising:
detecting a cleaning gesture received at the touchscreen, the cleaning gesture comprising one or more touch inputs on the touchscreen;
in response to receiving the cleaning gesture, entering a cleaning mode, the cleaning mode comprising disabling one or more functions and/or gestures of the touchscreen; and
conditionally terminating the cleaning mode.

17. The non-transitory computer readable medium according to claim 16, wherein the cleaning gesture comprises one or more selected from the group consisting of: swipe, tap, double-tap, rotate, pinch, spread, tap, hold, slide, drag, flick, circle gesture, multiple continuous offset circles, a zig-zag motion, and parallel or repeated swipes in a particular direction.

18. The non-transitory computer readable medium according to claim 16, wherein in the cleaning mode, a done-cleaning gesture is the only gesture enabled, the done-cleaning gesture comprising a gesture that causes the processor to terminate the cleaning mode.

19. The non-transitory computer readable medium according to claim 16, wherein the conditionally terminating the cleaning mode comprises one or more selected from the group consisting of:
terminating the cleaning mode after a fixed time has elapsed following the entering of the cleaning mode;
terminating the cleaning mode after sensing a time interval of no activity on the touchscreen;
terminating the cleaning mode after an image displayed on the touchscreen is traced with touch inputs; and
terminating the clean mode after receiving a done-cleaning gesture on the touchscreen, the done cleaning gesture being the only gesture enabled in cleaning mode.

20. The non-transitory computer readable medium according to claim 16, wherein the method further comprises:
renewing the cleaning mode, the renewing comprising delaying the conditionally terminating the cleaning mode.
